(19) United States
(12) Patent Application Publication
(10) Pub. No.: US 2005/0105936 A1
(43) Pub. Date: May 19, 2005

(54) Developing apparatus, process cartridge, electrophotographic image forming apparatus and end portion regulating member

(75) Inventors: Masanari Morioka, Shizouka (JP); Yoshiyuki Batori, Shizouka (JP); Hiroki Ogino, Shizouka (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/985,930

(22) Filed: Nov. 12, 2004

(30) Foreign Application Priority Data
Nov. 17, 2003 (JP) 2003-386310

(51) Int. Cl. G03G 15/09

(52) U.S. Cl. 399/274

(57) ABSTRACT

A developing apparatus, a process cartridge and an electrophotographic image forming apparatus which can obtain a good image, and an end portion regulating member provided in them. The end portion regulating members for regulating the layer thickness of developer passed through interstices between a developing blade for forming a layer of the developer having a predetermined thickness on the surface of a developing roller and magnetic seals provided on the longitudinally opposite end portions of the developing roller in opposed relationship with the surface of the developing roller is provided downstream of the developing blade with respect to the rotating direction of the developing roller.

### BACKGROUND OF THE INVENTION

1. Field of the Invention

The invention relates to a developing apparatus, a process cartridge, an electrophotographic image forming apparatus and an end portion regulating member.

2. Description of Related Art

Heretofore, a process cartridge system has been adopted in an electrophotographic image forming apparatus using an electrophotographic image forming process. This process cartridge system refers to a system whereby an electrophotographic photosensitive member and process means acting on the electrophotographic photosensitive member are integrally made into a cartridge, which is made detachable mountable to a main body of an image forming apparatus. According to this process cartridge system, the maintenance of the apparatus can be done by an operator himself without resort to a serviceman. Therefore the operability of the apparatus can be markedly improved. So, this process cartridge system is widely used in electrophotographic image forming apparatuses.

Also, in a developing apparatus used in the electrophotographic image forming apparatus, a stationary magnet is disposed in a hollow cylindrical developing roller. By the magnetic force of the magnet, a developer (hereinafter referred to as the “toner”) is attracted to the surface of the developing roller. The layer thickness of the toner adhering to the surface of the developing roller is regulated by a developing blade. By the developing roller being rotated, the toner is carried to a developing portion for visualizing a latent image.

As a method of preventing this toner from leaking out of a developing chamber, there is known a method of bringing a seal member such as belt into contact with the developing roller within the range outside an image formable area.

Also, there is known a method of disposing a ferromagnetic material as a seal member in non-contact with the developing roller, and holding the toner by the magnetic force thereof.

Also, there is known a construction in which a scraping-off member is disposed downstream of a seal member with respect to the rotating direction of the developing roller and a portion of the scraping-off member is brought into contact with the developing roller. This scraping-off member returns the toner having come out from the aforementioned seal member to the downstream side by the rotation of the developing roller again into a developing area so as not to leak outwardly (U.S. Pat. No. 6,205,304).

However, it has sometimes been the case that the developer leaks out along the rotating direction of the developing roller through interstices formed between the developing blade and the seal members provided on the end portions of the developing roller. When the developer leaking out through the interstices increases, there has been the possibility of the developer adhering to the electrophotographic photosensitive member.

### SUMMARY OF THE INVENTION

The present invention is the further development of the above-described conventional example.

It is an object of the present invention to regulate a developer leaking out along the rotating direction of a developing roller through interstices formed between a developing blade and seal members provided on the end portions of a developing roller.

It is another object of the present invention to decrease a developer unnecessarily adhering to an electrophotographic photosensitive member.

It is another object of the present invention to provide a developing apparatus, a process cartridge and an image forming apparatus which can obtain a good image, and an end portion regulating member provided in them.

It is another object of the present invention to provide a regulating portion for regulating the layer thickness of a developer when the layer thickness of the developer passed through an interstice formed between a layer thickness regulating member and a seal member in a longitudinal direction is a predetermined or greater layer thickness, and permitting the passage of the developer when the layer thickness of the developer is less than the predetermined layer thickness, the regulating portion having a gap with respect to the surface of a developing roller, downstream of a layer thickness regulating member with respect to the rotating direction of the developing roller.

These and other objects, features and advantages of the present invention will become more apparent upon consideration of the following description of the preferred embodiments of the present invention taken in conjunction with the accompanying drawings.

### BRIEF DESCRIPTION OF THE DRAWINGS

FIG. 1 is a cross-sectional view showing the construction of an electrophotographic image forming apparatus on which a process cartridge according to an embodiment of the present invention is mounted.

FIG. 2 is a cross-sectional view showing the construction of the process cartridge according to the embodiment.

FIG. 3 is a perspective view showing the guide member of an electrophotographic image forming apparatus according to an embodiment of the present invention.

FIG. 4 is a perspective view showing the guide member of the electrophotographic image forming apparatus according to the embodiment.

FIG. 5 is an exploded perspective view showing the step of assembling a developing apparatus.

FIG. 6 is an exploded perspective view showing the step of assembling the developing apparatus.

FIG. 7 is a front view of the vicinity of the seal member of a developing apparatus according to an embodiment of the present invention.

FIG. 8 is a cross-sectional view of a developing apparatus according to a first embodiment of the present invention.

FIG. 9A is a side view of an end portion regulating member according to the first embodiment, and FIG. 9B is a front view of the end portion regulating member.

FIG. 10 is a fragmentary perspective view of the developing apparatus in a state in which the end portion regulating member according to the first embodiment and a developing roller are mounted on a developing frame member.

FIG. 11 is a fragmentary front view of the developing apparatus in the state in which the end portion regulating member according to the first embodiment and the developing roller are mounted on the developing frame member as it is seen from Y direction in FIG. 8.

FIG. 12 is a fragmentary front view of the developing apparatus in a state in which an end portion regulating member according to a second embodiment of the present invention and the developing roller are mounted on the developing frame member as it is seen from Y direction in FIG. 8.

FIG. 13A is a side view of the end portion regulating member according to the second embodiment, and FIG. 13B is a front view of the end portion regulating member.

FIG. 14 is a cross-sectional view of a developing apparatus according to the second embodiment.

FIG. 15 is a fragmentary perspective view of the developing apparatus in a state in which the end portion regulating member according to the second embodiment and the developing roller are mounted on the developing frame member.

FIG. 16 is a fragmentary front view of a developing apparatus in which an end portion regulating member according to a third embodiment of the present invention and the developing roller are mounted on the developing frame member.

FIG. 17 is a cross-sectional view of a developing apparatus according to the third embodiment.

### DETAILED DESCRIPTION OF THE PREFERRED EMBODIMENTS

The best form for carrying out this invention will hereinafter be described with reference to the drawings and embodiments. However, the numerical values, materials, shapes, relative arrangements, etc. of constituent parts described in these embodiments are not intended to restrict the scope of this invention thereto unless particularly described. Also, the materials, shapes, etc. of members once described in the following description are similar to those described at first unless particularly newly described. Unless particularly explained in the following description, the “longitudinal direction” refers to the axial direction of a developing roller.

### First Embodiment

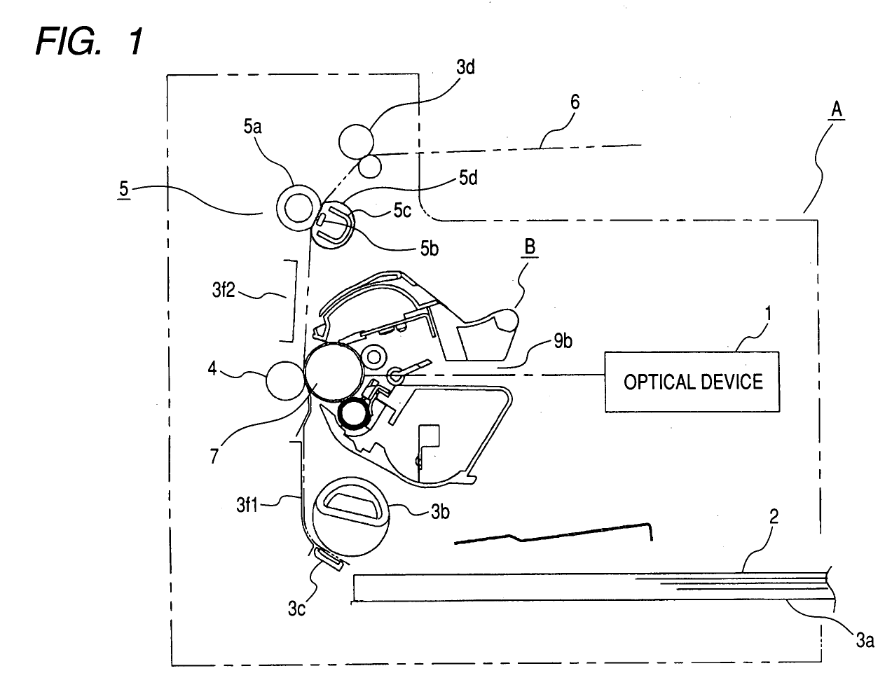

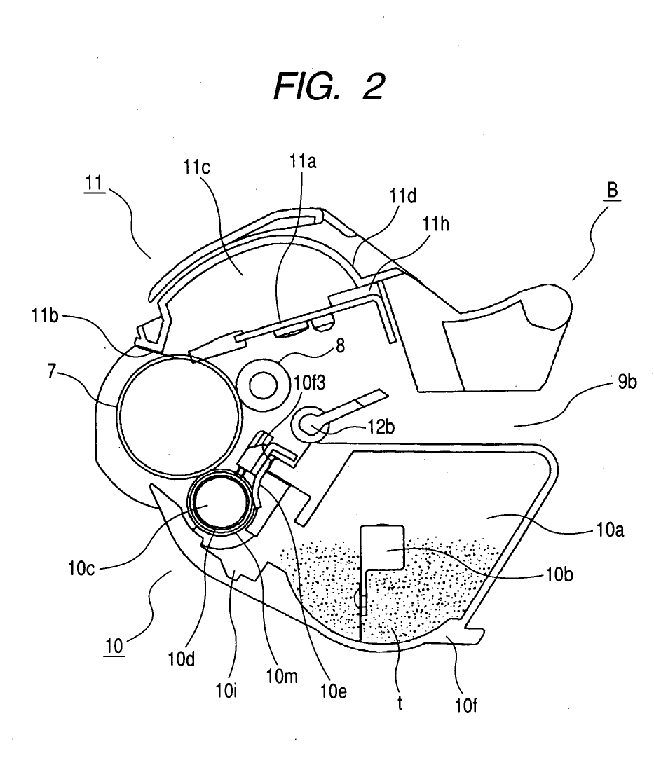

Reference is first had to FIGS. 1 and 2 to describe a process cartridge and an electrophotographic image forming apparatus to which it is detachably mountable. FIG. 1 is a cross-sectional view showing the construction of an electrophotographic image forming apparatus on which a process cartridge according to the present embodiment is mounted. FIG. 2 is a cross-sectional view showing the construction of a process cartridge according to the present embodiment.

(Electrophotographic Image Forming Apparatus)

As shown in FIG. 1, the electrophotographic image forming apparatus (laser beam printer, hereinafter referred to as the “image forming apparatus”) A applies light based on image information from an optical device 1 to a drum-shaped electrophotographic photosensitive member (hereinafter referred to as the “photosensitive drum”) 7. Thereby, an electrostatic latent image is formed on the photosensitive drum 7. Then, this electrostatic latent image is developed with a developer “t” (toner), whereby a developer image (toner image) is formed on the photosensitive drum 7.

Also, in synchronism with the forming of the developer image, recording mediums (such as recording paper, OHP sheets or cloth) 2 are separated and fed one by one from a cassette 3a by a pickup roller and a pressure contact member 3c which is in pressure contact therewith. The recording medium 2 fed out from the cassette 3a in conveyed to the area between a transfer roller 4 as transferring means and the photosensitive drum 7 along a conveying guide 3f1. The developer image formed on the photosensitive drum 7 is transferred to the recording medium 2 by the transfer roller 4 to which a voltage has been applied. Then, the recording medium 2 is conveyed to fixing means 5 along a conveying guide 3f2.

The fixing means 5 has a driving roller 5a and a fixing rotary member 5d comprised of a cylindrical sheet. The fixing rotary member 5d has a heater 5b therein, and is rotatably supported by a supporting member 5c. Heat and pressure are applied to the recording medium 2 by the fixing means 5. As a result, the toner image is fixed on the recording medium 2. Then, this recording medium 2 is conveyed by discharging rollers 3d and is discharged to a discharging portion 6. In the present embodiment, conveying means 3 is constituted by the pickup roller 3b, the pressure contact member 3c and the discharging rollers 3d.

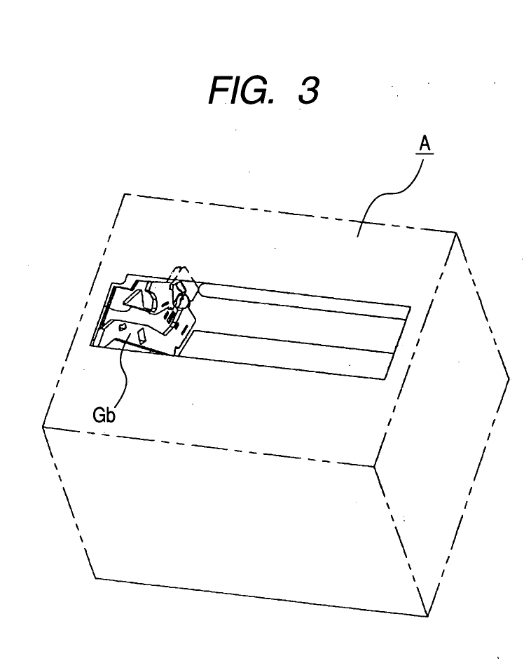

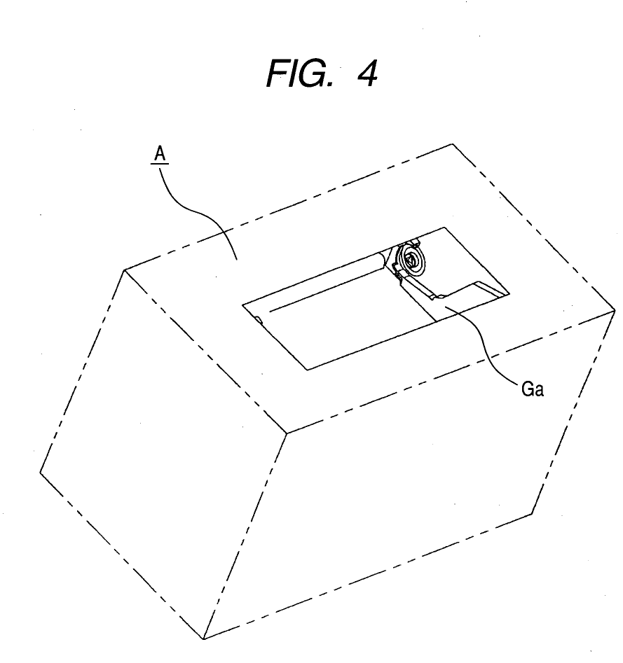

Also, as shown in FIGS. 3 and 4, the image forming apparatus A has guide members Ga and Gb (detachably mounting means) for guiding a process cartridge B which will be described later to a predetermined position. These guide members Ga and Gb are for making the cartridge B detachably mountable to the image forming apparatus A.

(Process Cartridge)

The process cartridge B is provided with the photosensitive drum 7 and at least one process means. As the process means, there are, for example, charging means for charging the photosensitive drum 7, developing means for developing the electrostatic latent image formed on the photosensitive drum 7, cleaning means for removing the developer “t” residual on the photosensitive drum 7, etc.

As shown in FIG. 2, the cartridge B has the rotatable photosensitive drum 7 and a charging roller 8 which is charging means for uniformly charging the surface of the photosensitive drum 7. The cartridge B further has an exposure opening 9b for passing therethrough light L for exposing the charged photosensitive drum 7. The light L is emitted from the optical device 1. The photosensitive drum 7 is exposed to this light L, whereby an electrostatic latent image is formed on the photosensitive drum 7. The cartridge B has a developing apparatus 10 for developing the electrostatic latent image, and cleaning means 11 for removing the developer “t” residual on the photosensitive drum 7.

(Developing Apparatus)

The developing apparatus 10 according to the present embodiment has a developing frame member 10f, a developing roller 10d, a developing blade (layer thickness regulating member) 10e, magnetic seals (seal members) 10r and end portion regulating members 10t as regulating members. The developing frame member 10f contains therein the developer “t” having magnetic powder. The developing roller 10d is rotatably supported by the developing frame member 10f, and carries the developer “t” thereon. Further, a stationary magnet (magnet member) 10c is provided in the interior of the developing roller 10d. Also, the developing blade 10e forms a layer of developer “t” having a predetermined thickness on the surface of the developing roller 10d. Also, the magnetic seals 10r are provided on the longitudinally opposite end portions of the developing roller 10d in opposed relationship with the surface of the developing roller 10d. Also, the end portion regulating member 10t has a regulating portion 10t2 for regulating the layer thickness of the developer “t” passed through the interstice between the developing blade 10e and the magnetic seal 10r. Also, a feeding member 10b feeds out the developer “t” in a developer containing portion 10a toward a developing chamber 10i by the rotation thereof.

The developing roller 10d is rotated. Together therewith, a layer of developer “t” given triboelectric charges by the developing blade 10e is formed on the surface of the developing roller 10d. Then, the developer “t” shifts to the photosensitive drum 7 in accordance with the electrostatic latent image. Thereby, a developer image is formed on the surface of the photosensitive drum 7.

The developer image formed on the surface of the photosensitive drum 7 is transferred to the recording medium 2 by a voltage opposite in polarity to the developer image being applied to the transfer roller 4. On the other hand, the developer “t” residual on the photosensitive drum 7 is scraped off by a cleaning blade 11a as the cleaning means 11. Then, the developer “t” scraped off from the photosensitive drum 7 is scooped by a scooping sheet 11b. Then, the scooped developer “t” is collected into a removed toner containing portion 11c.

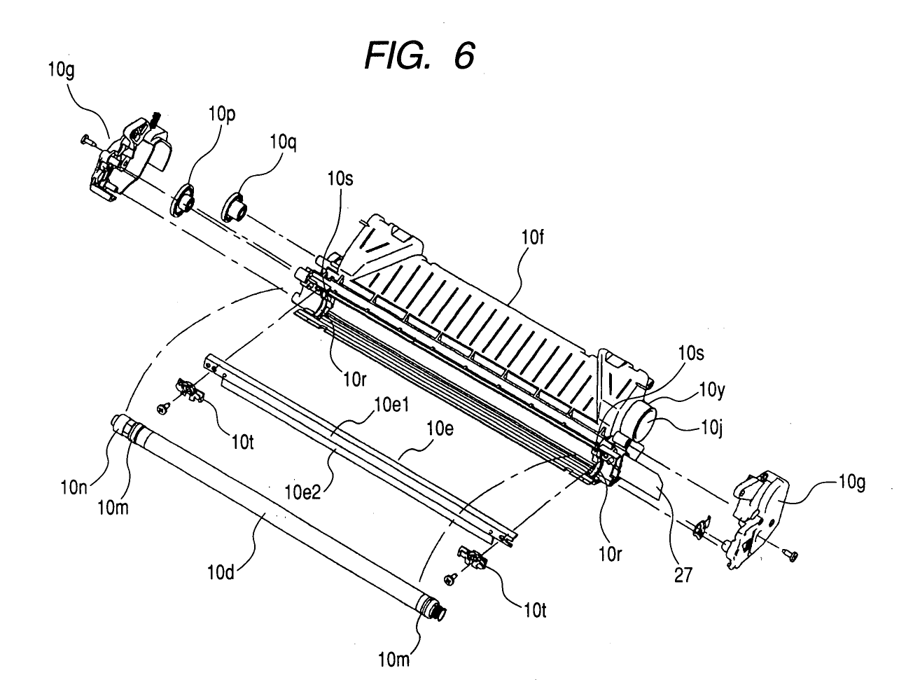

The developing frame member 10f is supported for pivotal movement relative to a cleaning frame member 11d so that the developing roller 10d may be opposed to the photosensitive drum 7 in parallelism thereto with a predetermined interval kept therebetween. Spacers 10m (see FIG. 6) for keeping the interval between the developing roller 10d and the photosensitive drum 7 are disposed on the opposite end portions of the developing roller 10d.

As shown in FIGS. 2, 5 and 6, the developing frame member 10f comprises a first frame member 10f1 and a second frame member 10f2 coupled together. The developing frame member 10f is provided with a developer containing portion 10a for containing the developer “t” therein, and a developing chamber 10i for supporting the developing roller 10d.

An agitating shaft 10b1 for agitating the developer “t” in the developer containing portion 10a is supported on the first frame member 10f1. A sheet member 10b2 is fixed to the agitating shaft 10b1. In order to receive the transmission of a driving force, a carrying gear 10b3 is fixed to the agitating shaft 10b1. The carrying gear 10b3 regulates the longitudinal position of the agitating shaft 10b1. In order to prevent the developer “t” from leaking from the developer containing portion 10a, a containing portion sealing member 10b4, together with the carrying gear 10b3, is mounted on the outside of the first frame member 10f1.

Also, the first frame member 10f1 is formed with a passage opening 10k. The developer “t” contained in the developer containing portion 10a passes through this passage opening 10k when it is supplied to the developing roller 10d.

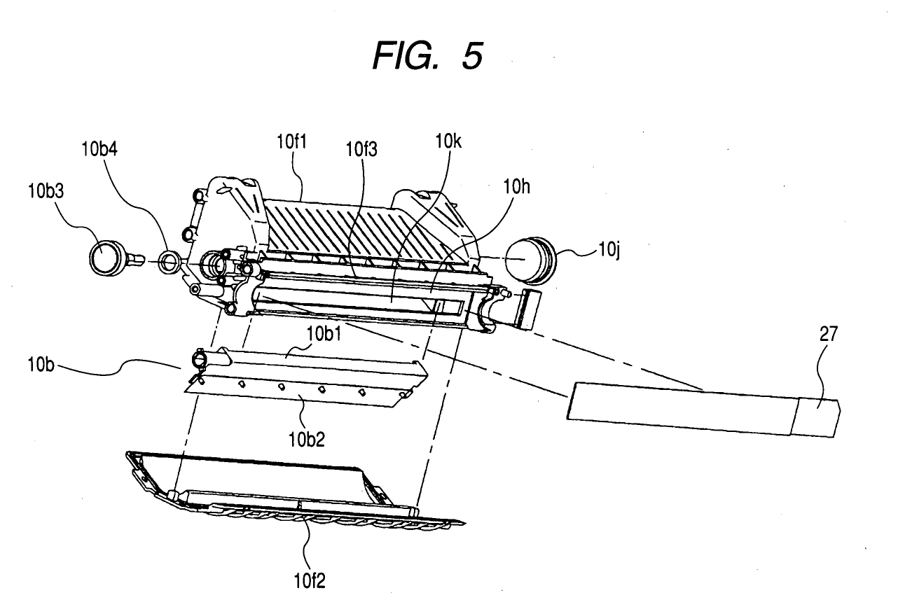

As shown in FIG. 5, a toner seal member 27 is fixed to a seal attaching portion 10h provided along the four side edges of the passage opening 10k.

Also, a developer filling port 10y for filling the developer containing portion 10a with the developer “t” is provided in one end of the first frame member 10f1 in the longitudinal direction thereof. This filling port 10y is sealed by a tap member 10j after the developer containing portion has been filled with the developer “t”.

Reference is now had to FIG. 6 to describe the step of incorporating the developing blade 10e and the developing roller 10d into the developing frame member 10f.

The first frame member 10f1 has magnetic seals 10r as seal members attached thereto. The magnetic seals 10r prevent the developer “t” from leaking out from the opposite end portions of the developing roller 10d. Also, leakage preventing members 10s are stuck on the first frame member 10f1 by a two-sided tape or the like. These leakage preventing members 10s prevent the developer “t” from leaking outwardly from the opposite ends of the developing blade 10e.

The developing blade 10e has a rubber portion 10e2 and a metal plate portion 10e1. The metal plate portion 10e1 supports the rubber portion 10e2. The opposite ends of the metal plate portion 10e1, together with end portion regulating members 10t, is fixed to the first frame member 10f1 by screws. The end portion regulating members lot make the thickness of the developer layer on the end portions of the developing roller 10d small and level it. A rib 10f3 formed by the distal end of the first frame member 10f1 becoming thin is set to such dimensions that it eats into the rubber portion 10e2. Accordingly, the space between the rubber portion 10e2 and the first frame member 10f1 is sealed by the rib 10f3.

Also, a drum gear (not shown) is fixed to an end portion of the photosensitive drum 7. Also, a developing roller gear 10n is fixed to an end portion of the developing roller 10d. The drum gear and the developing roller gear 10n are in meshing engagement with each other. Further, a gear train having two idler gears 10p and 10g is constructed. The gear train transmits drive from the developing roller gear 10n to the carrying gear 10b3 of a developer feeding member 10b. One of end portion members 10g disposed on the longitudinally opposite sides of the developing apparatus 10 covers the drum gear, the developing roller gear 10n and the gear train.

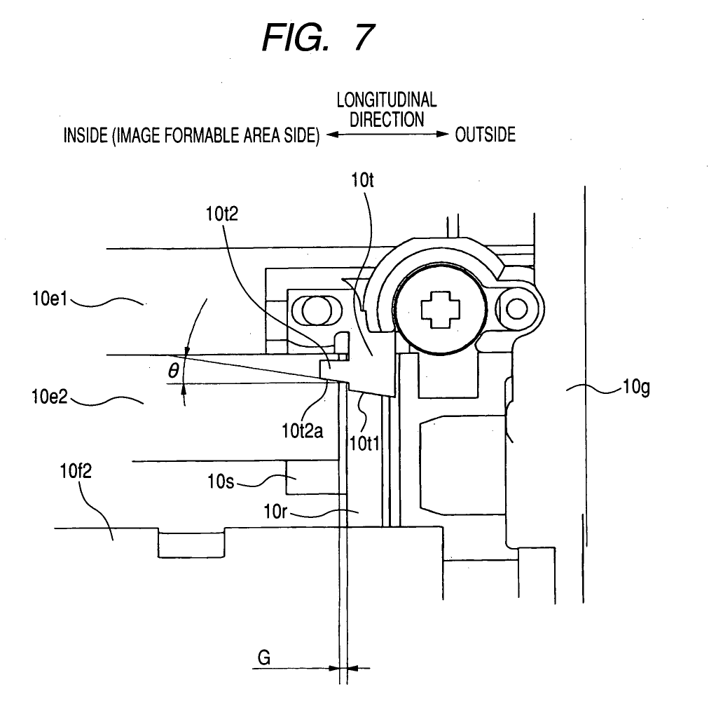

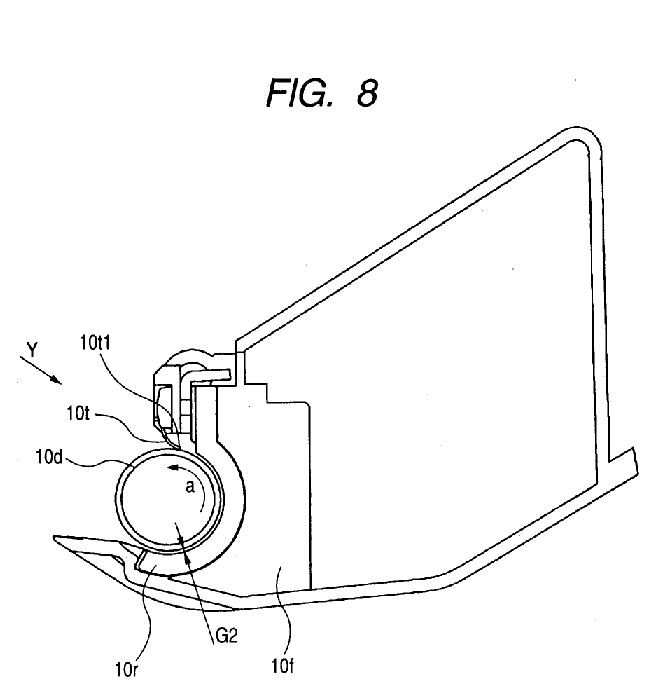

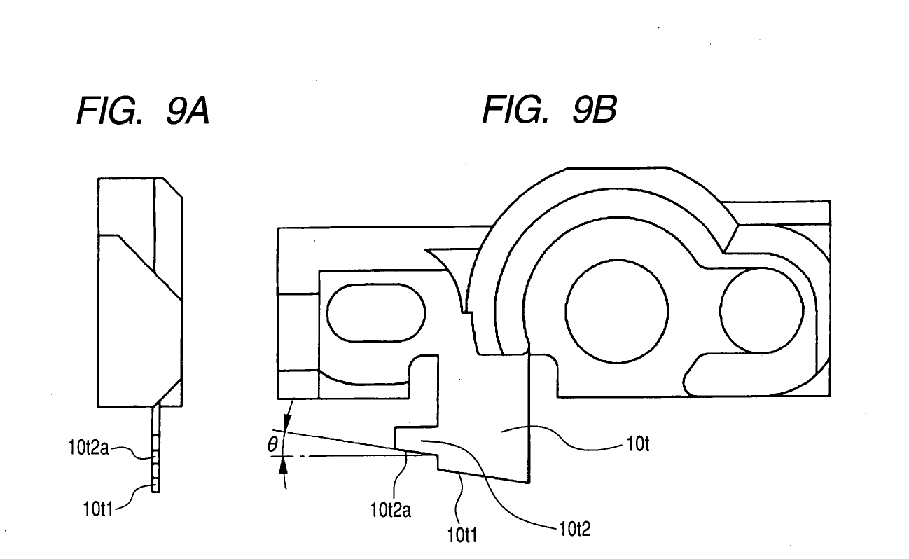

Reference is now had to FIGS. 7, 8, 9A and 9B to describe the construction of the vicinity of the seal member according to the present invention. FIG. 7 is a front view of the vicinity of the seal member of the developing apparatus according to the present embodiment. FIG. 8 is a cross-sectional view of the developing apparatus according to the present embodiment. FIG. 9A is a side view of the end portion regulating member 10t according to the present embodiment, and FIG. 9B is a front view of the end portion regulating member 10t.

In order to prevent the developer “t” from leaking out of the developing chamber 10i, the magnetic seals 10r are provided on the outside of the developing blade 10e in the longitudinal direction thereof. The magnetic seals 10r are provided in non-contact with the developing roller 10d in opposed relationship with the surface of the developing roller 10d. The magnetic seals 10r are ferromagnetic members (of the order of 2000G on the surfaces thereof).

By the magnetic force of the magnetic seals 10r, the developer “t” is held in the interstice portions G2 between the magnetic seals 10r and the developing roller 10d. Thereby, the developer “t” is prevented from leaking out of the cartridge B through these interstice portions G2.

Also, the developing apparatus 10 is provided with the end portion regulating members lot. The end portion regulating members 10t return the developer “t” passed through the interstice portions G2 by the rotation of the developing roller 10d again to the image formable area (the area longitudinally inward of the magnetic seals 10r).

The end portion regulating members 10t are provided downstream of the magnetic seals 10r and the developing blade 10e with respect to the rotating direction (the direction indicated by the arrow “a”) of the developing roller 10d. Also, a portion of each end portion regulating member 10t is in contact with the developing roller 10d. That is, as shown in FIG. 7, the end portion regulating members 10t overlap the respective magnetic seals 10r in the longitudinal direction. Further, in the longitudinal direction, the end portion regulating members 10t extend to the outer sides of the magnetic seals 10r.

The end portion regulating members 10t have scraping portions 10t1. The scraping portions 10t1 scrape off the developer “t” passed through the interstice portions G2 by the rotation of the developing roller 10d from the surface of the developing roller 10d before it arrives at the developing portion between the developing roller 10d and the photosensitive drum 7.

Also, in the present embodiment, an interstice G is formed between the rubber portion 10e2 and each magnetic seal 10r. Owing to this construction, it never happens even when the developing roller 10d, the magnetic seals 10r and the developing blade 10e are assembled to the developing frame member 10f that the rubber portion 10e2 is sandwiched between the developing roller 10d and the magnetic seals 10r. As a result, the pressure of the rubber portion 10e2 against the developing roller 10d can be prevented from becoming strong in the longitudinal end portions. Also, the interstice portion G between the developing roller 10d and each magnetic seal 10r can be stabilized.

The scraping portions 10t1 are provided at locations whereat at least a portion thereof overlaps the magnetic seals 10r in the longitudinal direction of the developing roller 10d. Further, the scraping portions 10t1 are in contact with the developing roller 10d. Thereby, even if the developer “t” leaks from the magnetic seals 10r, the scraping portions 10t1 can return the developer “t” to the image formable area. Also, the scraping portions 10t1 are of such a shape that with the developing roller 10d mounted on the developing frame member 10f, the contact positions thereof with the surface of the developing roller 10d lie on the downstream side with respect to the rotating direction of the developing roller 10d from the outside toward the inside of the developing roller 10d in the longitudinal direction thereof.

Therefore, the developer “t” scraped off by the scraping portions 10t1 receives a force toward the inside (the image formable area side) of the developing roller 10d in the longitudinal direction thereof while being carried by the rotation of the developing roller 10d. Thus, the scraped developer “t” is gradually moved to the image formable area side. As a result, the scraped developer “t” can be prevented from leaking out to the outside of the developing roller 10d in the longitudinal direction thereof.

As shown in FIGS. 7 and 9B, the distal end of the scraping portion 10t1 is obliquely cut with respect to the longitudinal direction with the developing roller 10d not assembled to the developing frame member 10f. Further, in the longitudinal direction, the outside of the scraping portion 10t1 is longer than the inside thereof. As a result, when the developing roller 10d is to be mounted on the developing frame member 10f, the outside of the distal end portion of the scraping portion 10f1 first contacts with the developing roller 10d and is deformed. Further, as the developing roller 10d is mounted on the developing frame member 10f, the distal end portion of the scraping portion 10t1 is deformed so as to twist from the outside toward the inside. As a result, the location at which the scraping portion 10t1 contacts with the developing roller 10d is on the downstream side with respect to the rotating direction of the developing roller 10d from the outside toward the inside of the developing roller 10d in the longitudinal direction thereof.

In the present embodiment, the scraping portion 10t1 is a thin plastic piece. The scraping portion 10t1 is flexed and is in contact with the peripheral surface of the developing roller 10d. As another example, the abutting portion of the scraping portion 10t1 against the developing roller 10d may be made into an arcuate shape conforming to the peripheral surface of the developing roller 10d.

Description will now be made of the regulating portions the end portion regulating members have.

With the end portion regulating member 10t assembled to the developing frame member 10f, at least a portion of the regulating portion 10t is provided at a location whereat it overlaps the interstice G between the magnetic seal 10r and the developing blade 10e (see FIG. 7). By doing so, the amount of the developer “t” passing through the interstice G can be regulated. Also, the regulating portion 10t2 is on the inside of the scraping portion 10t1 in the longitudinal direction. Also, the regulating portion 10t2 is coupled to the scraping portion 10t1. That is, the regulating portion 10t2 is provided so as to protrude from the scraping portion 10t1 toward the inside in the longitudinal direction. The regulating portion 10t2 regulates the layer thickness of the developer “t” and has a gap with respect to the peripheral surface of the developing roller 10d. Therefore, by the scraping portion 10t1 being positioned, the positioning of the regulating portion 10f2 can be made. Accordingly, the work of mounting the end portion regulating members 10t on the developing frame member 10f becomes easy.

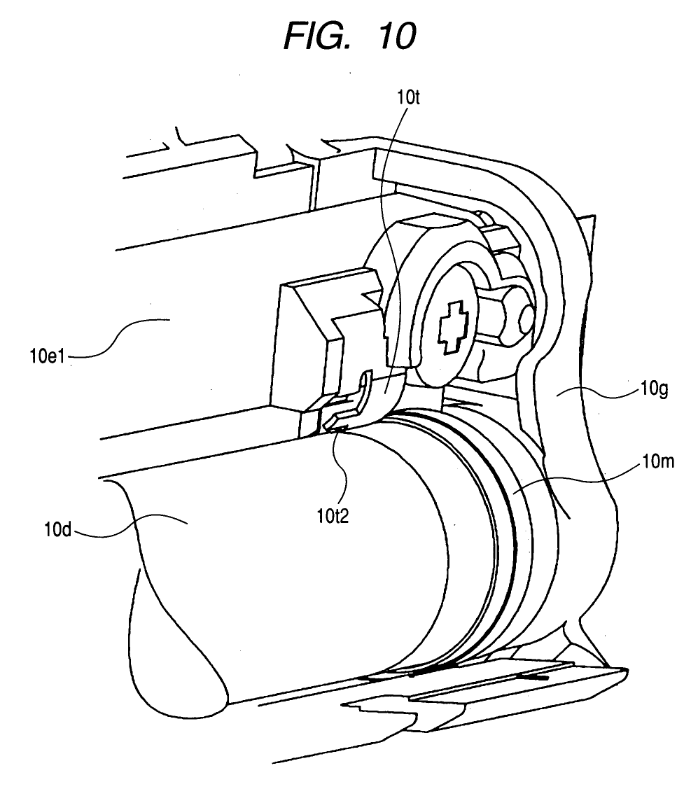

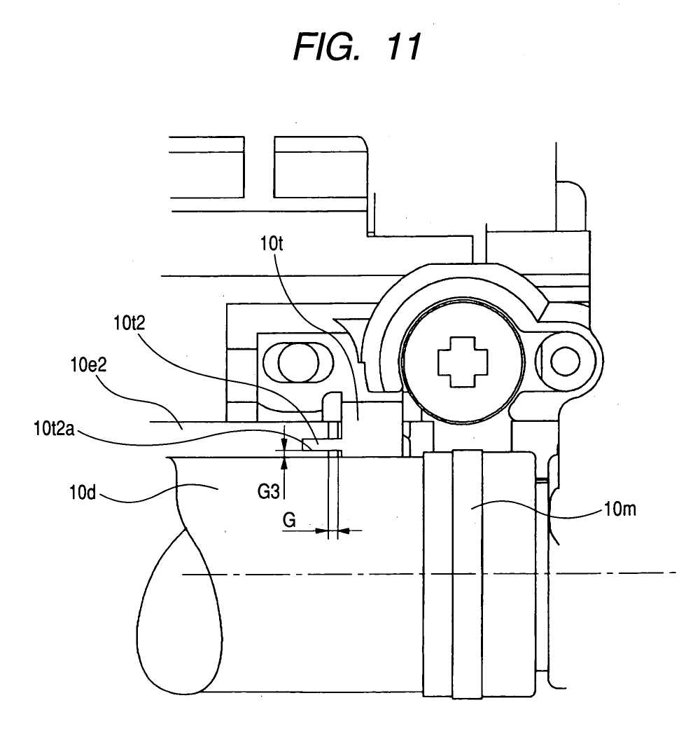

FIG. 10 is a fragmentary perspective view of the developing apparatus showing a state in which the end portion regulating members according to the present embodiment and the developing roller are mounted on the developing frame member. FIG. 11 is a fragmentary perspective view of the developing apparatus as it is seen from Y direction in FIG. 8 with the end portion regulating members according to the present embodiment and the developing roller mounted on the developing frame member.

As shown in FIGS. 10 and 11, in its assembled state, the regulating portion 10t1 has,a predetermined gap with respect to the developing roller 10d. At this time, the scraping portion 10t1 is twisted and is in contact with the developing roller 10d. As shown in FIGS. 7 and 9B, that side 10t2a of the regulating portion 10t2 which is opposed to the developing roller 10d is oblique so as to assume an angle θ with respect to the longitudinal direction. Therefore, a uniform gap G3 is formed between the regulating portion 10t2 and the developing roller 10d. Therefore, when the layer thickness of the developer “t” passed through the interstice G becomes a layer thickness equal to or greater than G3, the layer thickness can be regulated. Also, when the layer thickness of the developer “t” passed through the interstice G is a layer thickness less than G3, the passage of the developer “t” is permitted. Thereby, it is possible to regulate the layer thickness of the developer “t” to G3 or less without giving any excess load to the developer “t”.

Accordingly, by providing the above-described regulating portion 10t2, if the layer thickness is not regulated by the developing blade 10e but the developer layer carried from the interstice G has a layer thickness equal to or greater than G, the layer thickness can be made smaller. Thus, the developer “t” can be prevented from unnecessarily adhering to the photosensitive drum 7. As a result, the fogging of and the carrier adherence or the like to the end portions of an image formed on the recording medium can be prevented. Accordingly, a good image can be formed.

### Second Embodiment

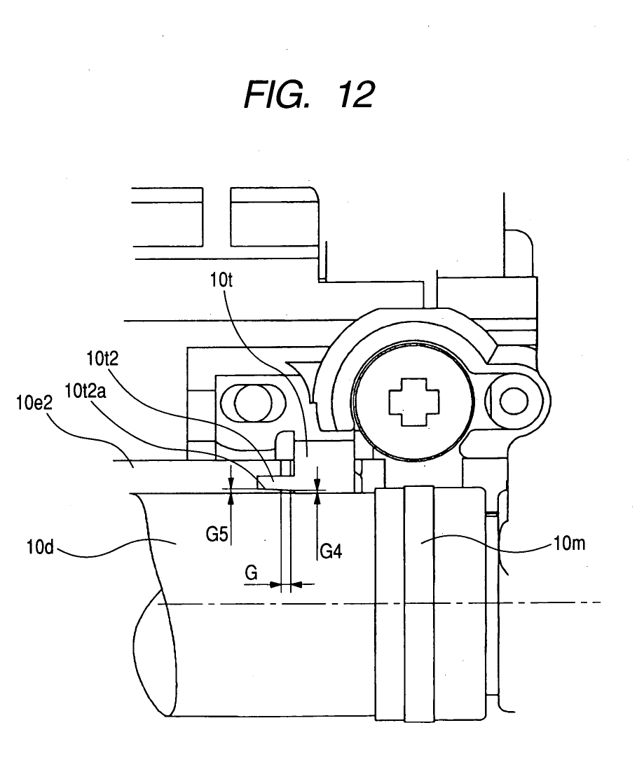

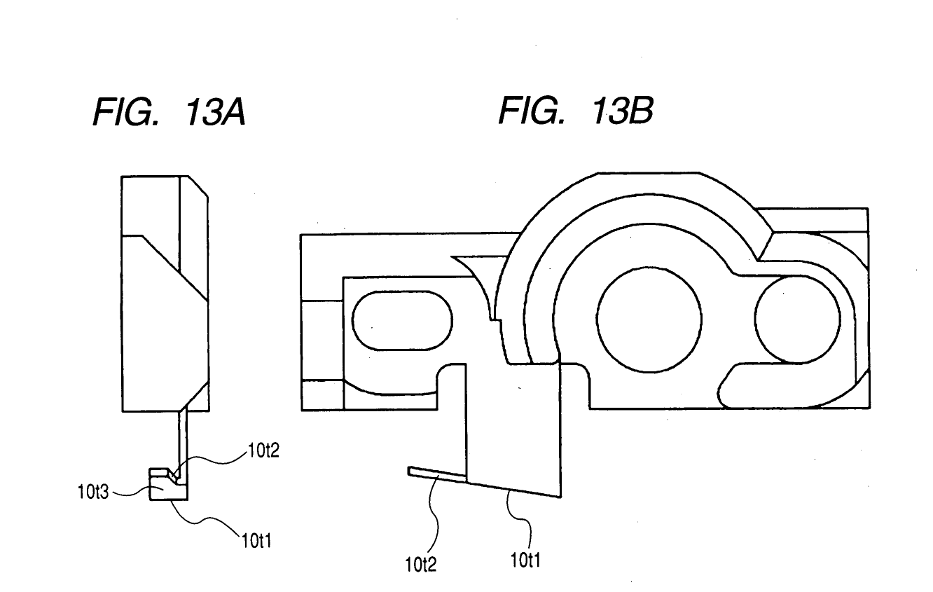

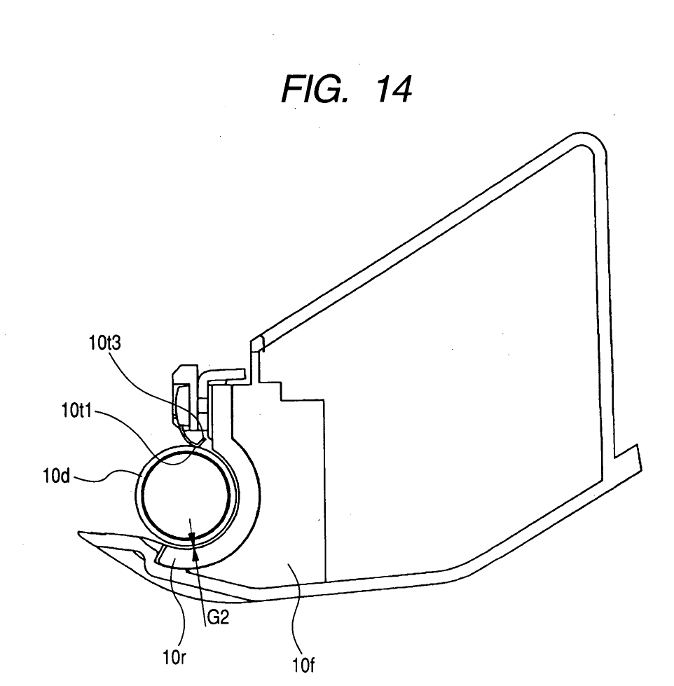

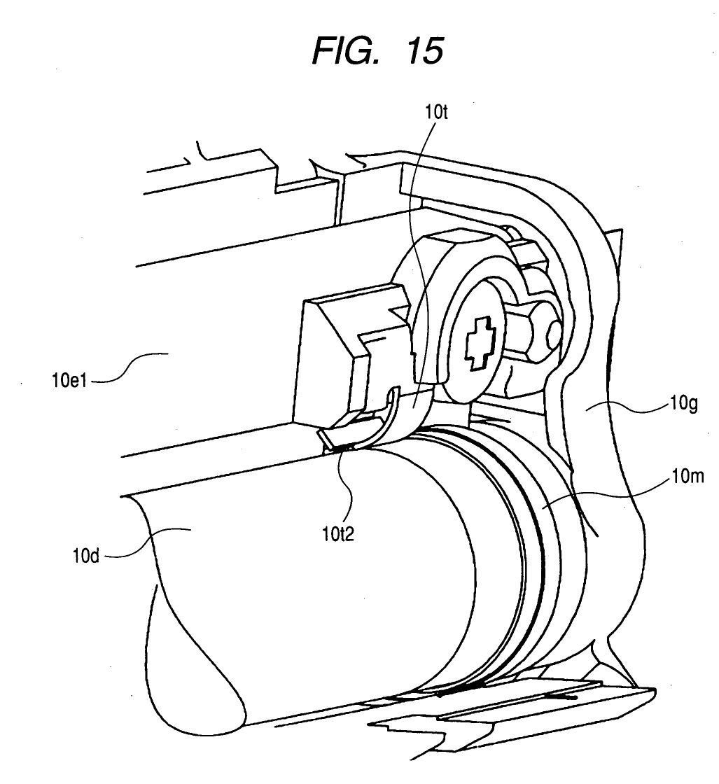

FIG. 12 is a fragmentary front view of the developing apparatus as it is seen from Y direction in FIG. 8 with end portion regulating members according to a second embodiment and the developing roller mounted on the developing frame member. FIG. 13A is a side view of the end portion regulating member according to the second embodiment, and FIG. 13B is a front view of the end portion regulating member. FIG. 14 is a cross-sectional view of a developing apparatus according to the second embodiment. FIG. 15 is a fragmentary perspective view of the developing apparatus in a state in which the end portion regulating portions according to the second embodiment and the developing roller are mounted on the developing frame member.

The regulating portion 10t2 according to the present embodiment is of such a shape that in the longitudinal direction of the developing roller 10d, the distance thereof from the developing roller 10d becomes greater from the outside toward the inside (see FIG. 12). That is, a gap G5 at the distal end of the regulating portion 10t2 is greater than a gap G4 near the coupled portion between the regulating portion 10t2 and the scraping portion 10t1.

Accordingly, the distance between the regulating portion 10t2 and the developing roller 10d gradually becomes greater, whereby even if the developer “t” scraped and gathered by the scraping portion 10t1 is greater in amount, the developer “t” can be prevented from locally gathering. That is, the layer thickness of the developer “t” can be leveled. Accordingly, the developer “t” can be prevented from unnecessarily adhering to the photosensitive drum 7. As a result, faulty images can be reduced. Consequently, good images can be obtained.

Also, the end portion regulating member 10t according to the present embodiment is of a shape in which the scraping portion 10t1 is bent. A damming-up portion 10t3 for preventing the developer “t” from accumulating is provided on a side opposite to a surface on which the scraping portion 10t1 contacts with the developing roller 10d. The damming-up portion 10t3 is extended to the regulating portion 10t2.

As a result, in a state in which the end portion regulating members 10t and the developing roller 10d have been incorporated into the developing apparatus 10, it can be alleviated for the developer “t” scraped off by the scraping portion 10t1 to accumulate on the upper side of the scraping portion 10t1. That is, when the damming-up portion 10t3 is absent, the developer “t” is liable to accumulate on the scraping portion 10t1 (see FIG. 8). However, when the damming-up portion 10t3 is present, it is difficult for the developer “t” to accumulate on the scraping portion 10t1 (see FIG. 14). Accordingly, it can be alleviated for the scraped developer “t” to flow out to the outside in the longitudinal direction of the scraping portion 10t1 along the upper side of the scraping portion 10t1.

### Third Embodiment

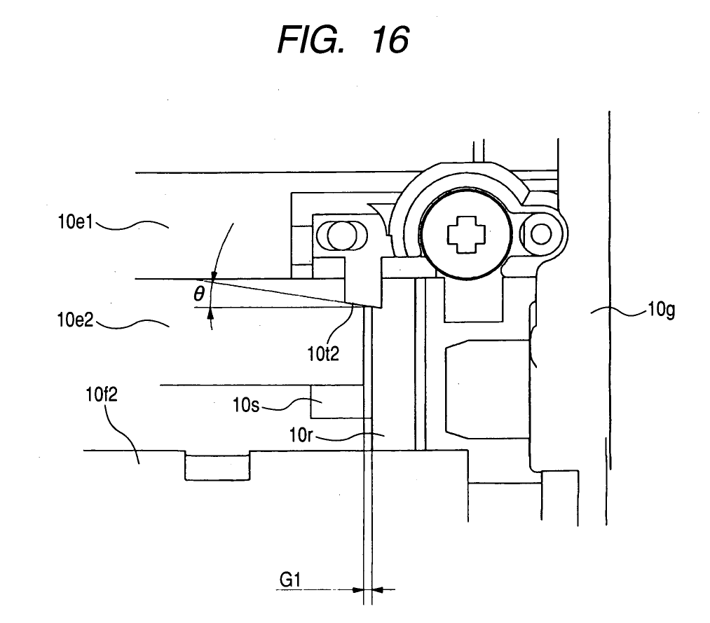

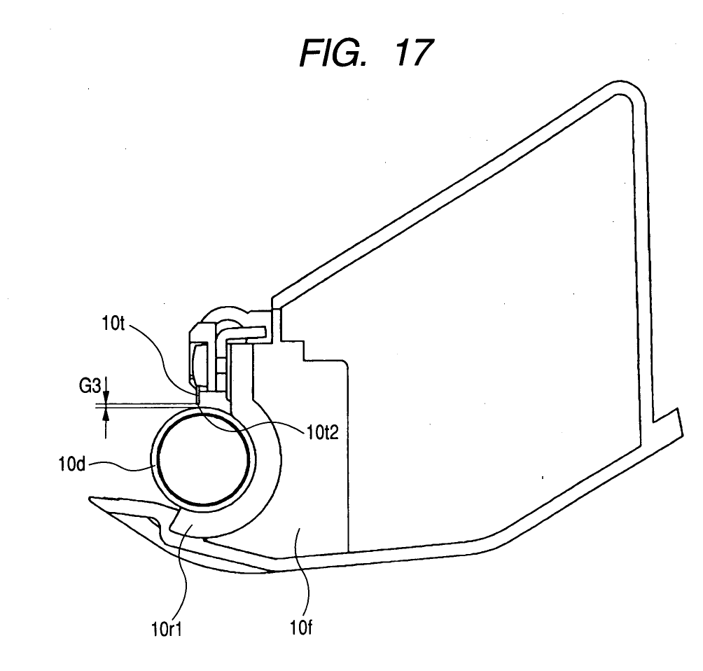

FIG. 16 is a fragmentary front view of the developing apparatus in a state in which end portion regulating members according to a third embodiment and the developing roller are mounted on the developing frame member. FIG. 17 is a cross-sectional view of a developing apparatus according to the third embodiment.

In the present embodiment, as end portion seal members, elastic seal members 10r1 such as felt are brought into contact with the developing roller 10d. That is, by the elastic seal members 10r1, the developer “t” is prevented from leaking out from the end portions of the developing roller 10d to the outside of the cartridge B.

At this time, there may be formed interstices G1 between the rubber portion 10e2 of the developing blade and the seal members 10r1. Therefore, the regulating portions 10t2 are disposed at a distance G3 from the developing roller 10d at a location whereat they overlap the interstices G1 in the longitudinal direction. As a result, they regulate the layer thickness of the developer “t” passed through the interstices G1 to a predetermined layer thickness. That is, the layer thickness of the developer “t” passed through the interstices G1 can be made small. As a result, the unnecessary adherence of the developer “t” to the photosensitive drum 7 can be prevented. Accordingly, faulty images can be reduced. Here, the magnetic seals 10r may be attached instead of the elastic seal members 10r1 (not shown). The relation between the respective members in the longitudinal direction is the same as that in the first embodiment and the second embodiment and therefore need not be described.

The process cartridge shown in the above-described embodiments has been shown with respect to a case where a single-color image is formed. The process cartridge according to the present invention, however, can also suitably be applied as a cartridge provided with a plurality of developing apparatuses to thereby form an image of plural colors (e.g. two colors, three colors or full color).

Also, the electrophotographic photosensitive member is not restricted to the photosensitive drum, but may be one of the following members. For example, a photoconductive material is used as the photosensitive member, and as the photoconductive material, there are included, for example, amorphous silicon, amorphous selenium, zinc oxide, titanium oxide and an organic photoconductive material (OPC). Also, as the shape carrying the photosensitive member thereon, use can be made, for example, of a drum shape or a belt shape. Also, in a drum type photosensitive member, a photoconductive material may be vapor-deposited or applied onto a cylinder of an aluminum alloy or the like.

Also, as the developing method, use can be made of one of various methods using a developer having magnetic powder, such as a magnetic one-component developing method using a magnetic toner as the developer, and a two-component magnetic brush developing method using a developer consisting of a magnetic carrier and a toner.

Also, as the cleaning means for the developer residual on the photosensitive drum, use may be made of such cleaning means as a blade, a fur brush or a magnetic brush.

Also, in the aforedescribed embodiments, in the process cartridge detachably mountable to the image forming apparatus, the cleaning blade 11a is used to remove the toner residual on the photosensitive drum 7. A similar effect, however, can also be obtained in a cleanerless construction having no cleaning blade.

Also, the electrophotographic image forming apparatus can be any one which forms an image on a recording medium (such as recording paper, an OHP sheet or cloth) by the use of the electrophotographic image forming process. Examples of the electrophotographic image forming apparatus include an electrophotographic copying machine, an electrophotographic printer (such as a laser printer or an LED printer), a facsimile apparatus, a word processor and a compound machine comprising these (such as a multi-function printer).

Also, the process cartridge refers to at least developing means as process means and an electrophotographic photosensitive drum integrally made into a cartridge which is made detachably mountable to the main body of an electrophotographic image forming apparatus. Accordingly, as shown in the aforedescribed embodiments, charging means and cleaning means may be further added as the process means.

The aforedescribed embodiments may be summed up as follows.

A developing apparatus 10 for developing an electrostatic latent image formed on an electrophotographic photosensitive member (photosensitive drum 7), having:
a developing roller 10d for carrying thereon a developer “t” having magnetic powder;
a magnetic member (stationary magnet 10c) provided in the interior of the developing roller 10d;
a layer thickness regulating member (developing blade 10e) provided along the longitudinal direction of the developing roller 10d for regulating the layer thickness of the developer “t” adhering to the surface of the developing roller 10d;
seal members (magnetic seal 10r, elastic seal member 10r1) provided outside the layer thickness regulating member (developing blade 10e) in the longitudinal direction in opposed relationship with the surface of the developing roller 10d; and
end portion regulating members 10t having regulating portions 10t2 for regulating the layer thickness of the developer “t” when the layer thickness of the developer “t” passed through interstices formed between the layer thickness regulating member (developing blade 10e) and the seal members (magnetic seal 10r, elastic seal member 10r1) in the longitudinal direction is equal to or greater than a predetermined layer thickness, and permitting the passage of the developer “t” when the layer thickness of the developer “t” is less than the predetermined layer thickness, the regulating portions 10t2 being provided downstream of the layer thickness regulating member (developing blade 10e) with respect to the rotating direction of the developing roller 10d, and having a gap with respect to the surface of the developing roller 10d.

The regulating portions 10t2 are such that the gap thereof with respect to the surface of the developing roller 10d becomes greater from the outside toward the inside thereof in the longitudinal direction.

The regulating portions 10t2 are provided at locations whereat at least a portion thereof overlaps the interstices in the longitudinal direction.

Further, the end portion regulating members 10t have scraping portions 10t1 for scraping off the developer “t” from the developing roller 10d, and the scraping portions 10t1 are provided outside the regulating portions 10t2 with respect to the longitudinal direction.

Further, the scraping portions 10t1 are provided at locations whereat in the longitudinal direction at least a portion thereof overlaps the seal members (magnetic seal 10r, elastic seal member 10r1), and are in contact with the developing roller 10d.

Further, the scraping portions 10t1 are provided in such a manner that from the outside toward the inside in the longitudinal direction, the contact positions thereof with the developing roller 10d are inclined toward the downstream side with respect to the rotating direction of the developing roller 10d.

Further, the scraping portions 10t1 are provided with damming-up portions 10t3 for damming up the developer “t” on a side opposite to a surface contacting with the developing roller 10d, so that the developer “t” may not accumulate on the opposite side.

According to the present invention, when the developer passed through the interstices between the seal members and the layer thickness regulating member increases more than a predetermined level, the layer thickness thereof can be regulated by the end portion regulating members.

Also, according to the present invention, the amount of the developer unnecessarily adhering to the electrophotographic photosensitive member can be decreased.

While the invention has been described with reference to the structure disclosed herein, it is not confined to the details set forth and the application is intended to cover such modifications or changes as may come within the purpose of the improvements or the scope of the following claims.

This application claims priority from Japanese Patent Application No. 2003-386310 filed Nov. 17, 2003, which is hereby incorporated by reference herein.

1. A developing apparatus for developing an electrostatic latent image formed on an electrophotographic photosensitive member, said developing apparatus comprising:
a developing roller for developing said electrostatic latent image by use of developer;
a magnetic member provided in said developing roller;
a layer thickness regulating member provided along a longitudinal direction of said developing roller for regulating a layer thickness of the developer adhering to a surface of said developing roller;
a seal member provided outside said layer thickness regulating member in said longitudinal direction in opposed relationship with the surface of said developing roller; and
a regulating portion for regulating the layer thickness of the developer when the layer thickness of the developer passed through an interstice formed between said layer thickness regulating member and said seal member in said longitudinal direction is equal to or greater than a predetermined layer thickness, and permitting a passage of said developer when the layer thickness of said developer is less than the predetermined layer thickness, said regulating portion being provided downstream of said layer thickness regulating member with respect to a rotating direction of said developing roller, and having a gap with respect to the surface of said developing roller.

2. A developing apparatus according to claim 1, wherein the gap between said regulating portion and the surface of said developing roller becomes greater from an outside toward an inside of said regulating portion in said longitudinal direction.

3. A developing apparatus according to claim 1, wherein said regulating portion is provided at a location whereat at least a portion thereof overlaps said interstice in said longitudinal direction.

4. A developing apparatus according to claim 1, further comprising a scraping portion for scraping off said developer from said developing roller, said scraping portion being provided outside said regulating portion with respect to said longitudinal direction.

5. A developing apparatus according to claim 4, wherein said scraping portion is provided at a location whereat in said longitudinal direction, at least a portion thereof overlaps said seal member, and is in contact with said developing roller.

6. A developing apparatus according to claim 5, wherein said scraping portion is provided in such a manner that from an outside toward an inside in said longitudinal direction, the contact portion thereof with said developing roller is inclined toward the downstream side with respect to the rotating direction of said developing roller.

7. A developing apparatus according to claim 5, wherein said scraping portion has a damming-up portion for damming up the developer on a side opposite to a surface contacting with said developing roller, so that the developer may not accumulate on said opposite side.

8. A process cartridge detachably mountable to a main body of an electrophotographic image forming apparatus, said process cartridge comprising:
an electrophotographic photosensitive member; and
a developing apparatus for developing an electrostatic latent image formed on said electrophotographic photosensitive member, said developing apparatus including:
a developing roller for developing said electrostatic latent image by use of developer;
a magnetic member provided in said developing roller;
a layer thickness regulating member provided along a longitudinal direction of said developing roller for regulating a layer thickness of the developer adhering to a surface of said developing roller;
a seal member provided outside said layer thickness regulating member in said longitudinal direction in opposed relationship with the surface of said developing roller; and
a regulating portion for regulating the layer thickness of the developer when the layer thickness of the developer passed through an interstice formed between said layer thickness regulating member and said seal member in said longitudinal direction is equal to or greater than a predetermined layer thickness, and permitting a passage of said developer when the layer thickness of said developer is less than the predetermined layer thickness, said regulating portion being provided downstream of said layer thickness regulating member with respect to a rotating direction of said developing roller, and having a gap with respect to the surface of said developing roller.

9. An electrophotographic image forming apparatus comprising:
conveying means for conveying a recording medium; and
a process cartridge according to claim 8 detachably mounted on a mounting portion.

10. An electrophotographic image forming apparatus comprising:
conveying means for conveying a recording medium; and
a developing apparatus according to any one of claims 1 to 7.

11. An end portion regulating member for use in a developing apparatus for developing an electrostatic latent image formed on an electrophotographic photosensitive member, said developing apparatus having a developing roller for carrying developer thereon, a magnetic member provided in said developing roller, a layer thickness regulating member provided along the longitudinal direction of said developing roller for regulating the layer thickness of the developer adhering to a surface of said developing roller to a predetermined layer thickness, and a seal member provided outside said layer thickness regulating member with respect to said longitudinal direction in opposed relationship with the surface of said developing roller, said end portion regulating member comprising:
a regulating portion for regulating the layer thickness of said developer when the layer thickness of the developer passed through an interstice formed between said layer thickness regulating member and said seal member is equal to or greater than a predetermined layer thickness, and permitting a passage of said developer when the layer thickness of said developer is less than the predetermined layer thickness, said regulating portion being provided downstream of said layer thickness regulating member with respect to a rotating direction of said developing roller, and having a gap with respect to the surface of said developing roller.

12. An end portion regulating member according to claim 11, further comprising a scraping portion for scraping off said developer from said developing roller, said scraping portion being provided outside said regulating portion with respect to said longitudinal direction.

13. An end portion regulating member according to claim 12, wherein said scraping portion has a damming-up portion for damming up the developer on a side opposite to a surface contacting with said developing roller, so that the developer may not accumulate on said opposite side.
